(19) United States
(12) Patent Application Publication
(10) Pub. No.: US 2007/0113433 A1
(43) Pub. Date: May 24, 2007

(54) Pop-up structures with electronics

(75) Inventor: Tom Moore, Allentown, PA (US)

Correspondence Address: BURNS & LEVINSON, LLP;(FORMERLY PERKINS SMITH & COHEN LLP), 125 SUMMER STREET, BOSTON, MA, 02110, US

(73) Assignee: Creative Strategy Group, Inc., Newton, PA (US)

(21) Appl. No.: 11/592,839

(22) Filed: Nov. 3, 2006

Related U.S. Application Data
(60) Provisional application No. 60/733,249, filed on Nov. 3, 2005.

(51) Int. Cl. G09F 1/00

(52) U.S. Cl. 40/124.08

(57) ABSTRACT

The present invention is directed to pop-up structures, with integrated electronic components.

### RELATED APPLICATIONS

This application claims priority to and the benefit of provisional application Ser. No. 60/733,249, filed Nov. 3, 2005; the entire contents of which are incorporated herein by reference.

### BACKGROUND OF THE INVENTION

Promotional pieces or novelty items such as pop-up calendars, advertising devices, etc. are generally used for conveying information and for decorating purposes.

### SUMMARY OF THE INVENTION

The present invention is directed to pop-up structures, which incorporate electronic components. The pop-up structures are also referred to three-dimension display structures herein.

The pop-up structures are flat or substantially co-planar in an unassembled state and expand in size into a three-dimensional assembled state. The pop-up structures are made of a stiff foldable material, such as paper or cardboard. Other natural or man-made materials can be used, for example, but not limited to, leather or various types of plastics.

One or more electronic components are inserted and contained in at least one opening of the structure. The electronic components are held in at least one opening of the structure by an attachment means, such as, but not limited to, face-plates, hooks, brackets, clips, pins, screws, or adhesives.

The electronic components include, but are not limited to, clocks, calculators, calendars, weather stations, thermometers, radios, televisions, phones, speakers, two-way communication devices, alarms, motion or vibration detectors, data recorders, audio recorders, portable media players, running liquid crystal display (LCD) message banners or other viewing screens.

The pop-up structure can include printed elements such as designs, logos, and advertisements. Any variety of colors fonts and styles can be incorporated. In addition to printed elements applied with ink, paint or other dyes, the printed elements can be added by stamping, carving, etching, embossing and the like. Printed elements can also be included or inserted in openings of the structure.

### BRIEF DESCRIPTION OF THE DRAWINGS

FIG. 1 is a picture of a support structure in the shape of a truck, in an unassembled state;

FIG. 2 is a picture of a support structure in the shape of a truck, in an assembled state;

FIGS. 3 A-D are diagrams of a support structure in the shape of a truck in various stages of assembly;

FIGS. 4 A-E are pictures of assembled support structures in the shape of a house, a pyramid, a slot machine, a cube and a hexagon, respectively;

FIG. 5 is a picture of a support structure in the shape of a house, in an unassembled state;

FIGS. 6 A-E are diagrams of a support structure in the shape of a house in various stages of assembly;

FIG. 7 is a picture of a support structure in the shape of a pyramid, in an unassembled state;

FIG. 8 is a picture of a support structure in the shape of a slot machine, in an unassembled state;

FIG. 9 is a picture of a support structure in the shape of a cube, in an unassembled state;

FIG. 10 is a picture of a support structure in the shape of a hexagon, in an unassembled state;

FIG. 11 is a picture of an exemplary electronic device, in this case a clock; and

FIGS. 12 A and B are pictures of the clock component with the face plate removed and the back side of the face plate, respectively.

### DETAILED DESCRIPTION OF THE INVENTION

The invention relates to a combination a collapsible, flattenable pop-up structure formed of stiff foldable material, such as, but not limited to, paper, cardboard, leather or plastics with integrated electronics, and is referred to herein as Promo-Pops™. In the collapsed mode the structure is flattened into a thin substantially co-planar structure for storage or shipment. In the pop-up, assembled mode the structure is 3-dimensional. The pop-up contains at least one opening on at least one face of the 3-dimensional structure for insertion of an electronic device or printed promotional or aesthetic material.

A collapsible structure or display device is provided, in which the device is preferably constructed of a single sheet of material such as paper, cardboard, leather or plastic. The material is folded back over itself along fold lines to form a multi-layered, flattened, substantially co-planar structure. The fold lines may be perforations, indentations, scored lines, or the like, which allow for bending of the material along a definitive line but serves to prevent breaking or tearing. When perforations are provided, the perforations are spaced a sufficient distance apart so as to reduce the risk of tearing or separation.

Promo-Pops™ can be utilized for a number of different purposes, such as, for example, a direct mail piece or promotional product giveaway. The folded or collapsed configuration provides for ease of storage and/or shipment until being assembled and used by the target audience. The electronics, in turn, provide an added functional component, so that the target audience may continue to use the Promo-Pops™ item for an extended period of time. In addition, the Promo-Pops™ item may include a design element for aesthetic reasons and/or an advertising element on the support structure and/or the electronics, such as a company name, which would be readily visible in use. As a result, each time the recipient uses the electronic component, they also see the advertising element. Additional features can be incorporated such as desk organizers such as a brochure holder, business card holder, floppy disc holder, CD/DVD holder, or holders or containers for writing implements (pens, pencils, etc.), paper clips, push pins, rubber bands, coins, or holders or dispensers for tape, notepads and the like.

For purposes of illustration and without limitation, the electronic component may comprise one or more of clocks, calculators, calendars, weather stations, thermometers, radios, televisions, phones, speakers, two-way communication devices, alarms, motion or vibration detectors, data recorders, audio recorders, portable media players, running liquid crystal display (LCD) message banners or other viewing screens. A portable media player is a flash memory or hard drive-based music, video, and media content player.

The display device or support structure is constructed of a single sheet of a material and is folded over itself to form a multi-layered flattened construction. The material is of a thickness and weight sufficient to prevent bending or sagging of the device during use, it also provides a rigidity necessary to avoid inadvertent collapsing of the device when it is in the assembled position, and is of a strength sufficient to support the electronic component(s) and any additional features.

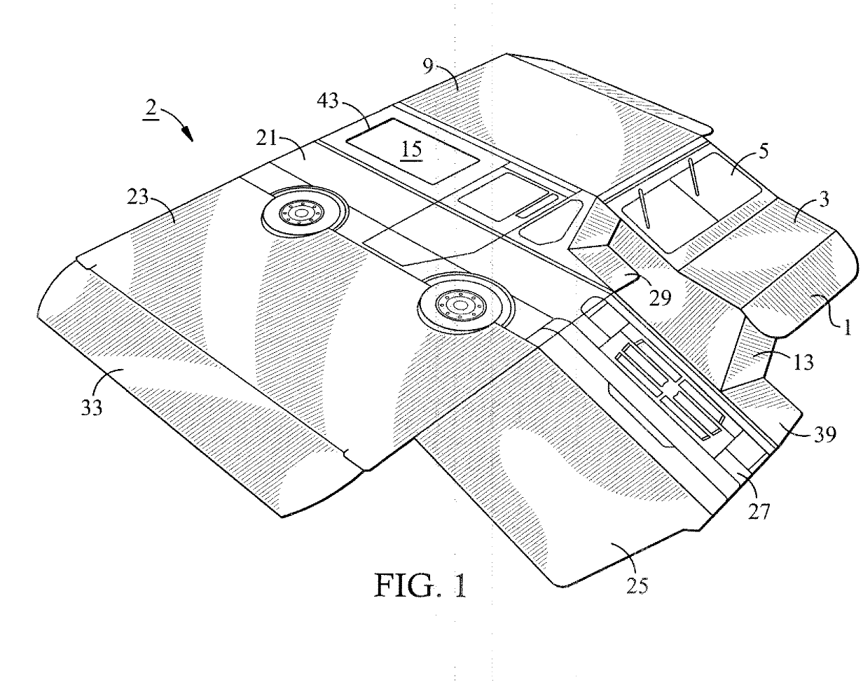

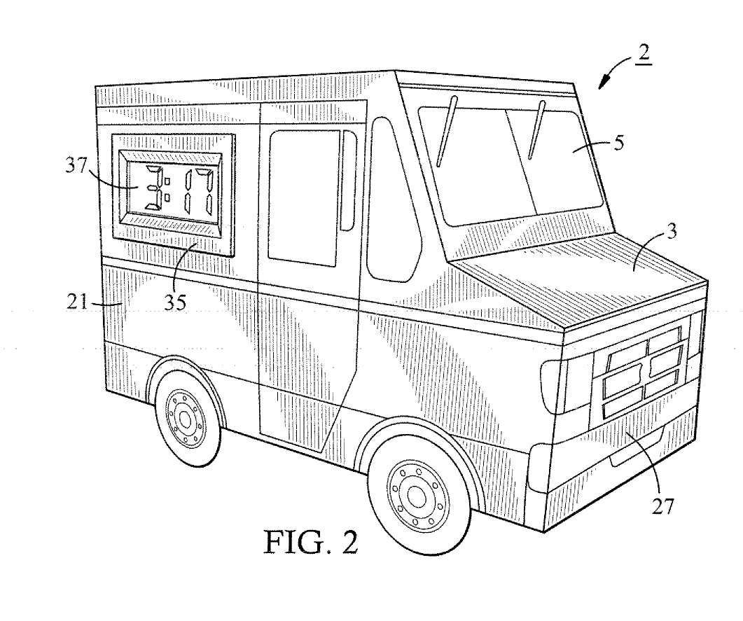

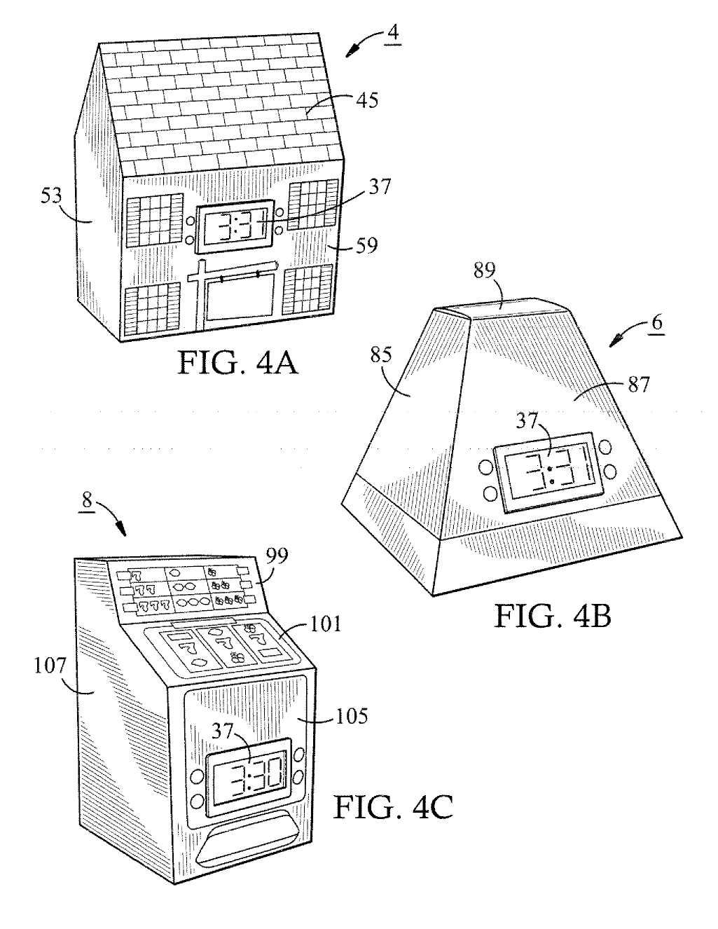

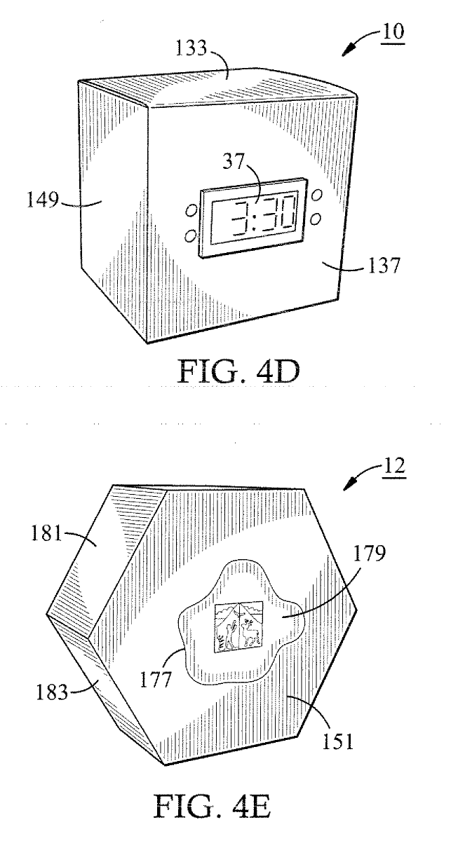

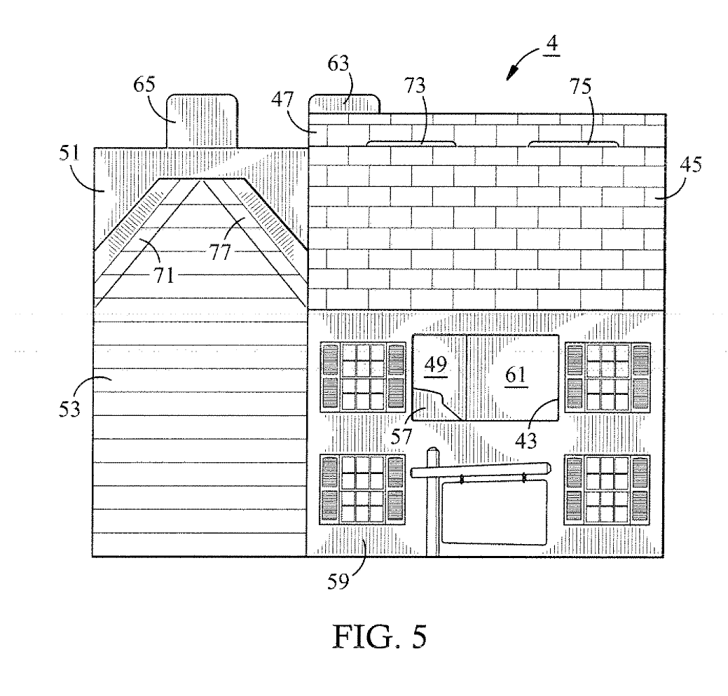

FIGS. 1, 5, and 7-10 show examples of support structures in a flattened state. When assembled the support structures form three-dimensional display devices. A variety of regular and irregular shapes can form the support structures. For example, a truck (FIG. 2), a house (FIG. 4A), a pyramid (FIG. 4B), a slot machine (FIG. 4C), a cube (FIG. 4D), and a hexagon (FIG. 4E). These are meant to be representative examples. Other and more general shapes and objects that can form the support structures include, but are not limited to, other vehicles including cars, buses, and trains; other buildings including schools, high rises, and monuments; other machines including appliances such as washing machines, dryers and refrigerators, and other geometric shapes, including triangles, rectangles, pentagons, heptagons, octagons, etc. Additional objects could include books, televisions, stereos, computers, jukeboxes, antique cars or trucks, school bus, sleighs, snowman, churches, diners, banks, teeth, tools, boats, cruise ships, yachts, mailboxes, arcade games, 16-wheelers, moving trucks, airplanes, trash cans, fire trucks, police cars, ambulances, slot machines, casinos and the like.

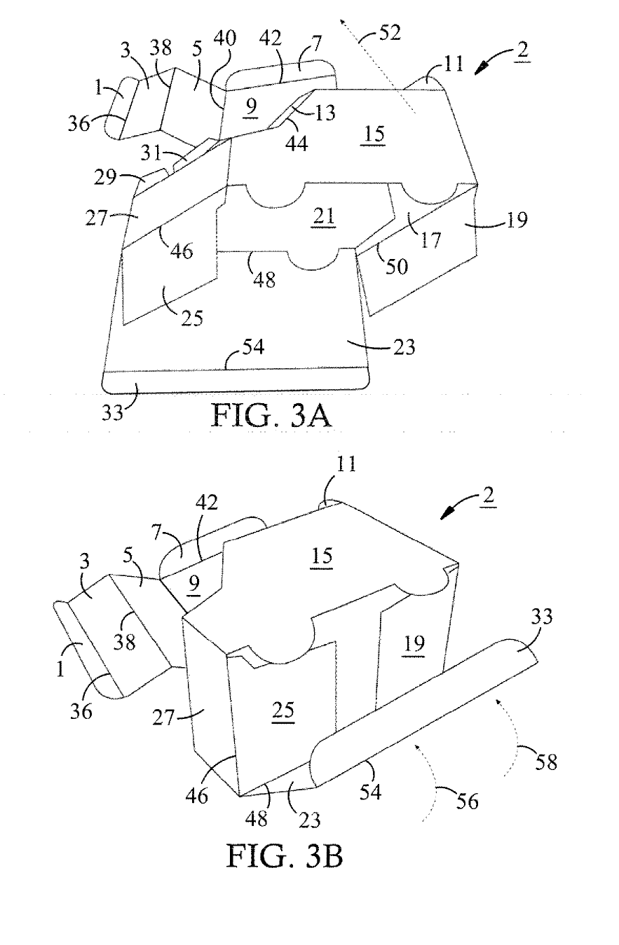

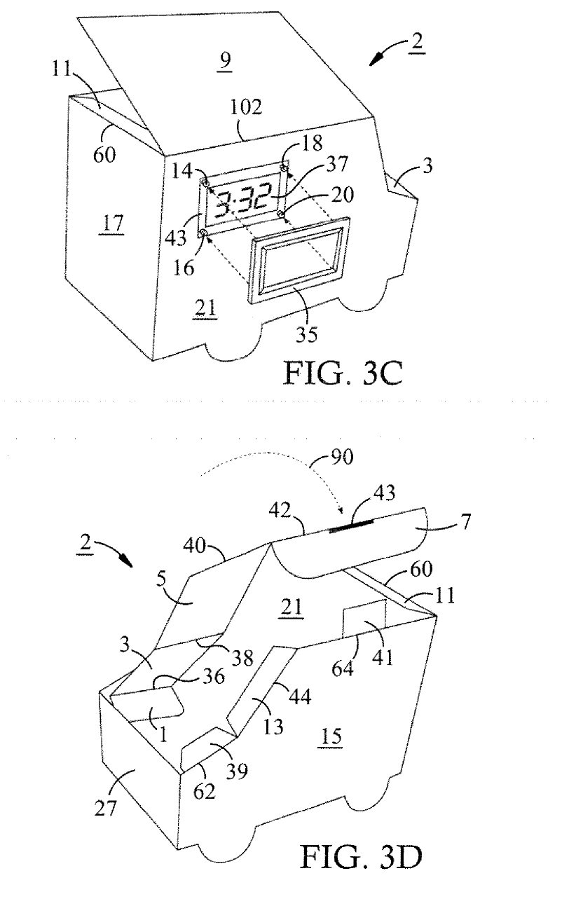

One embodiment of the invention is shown in FIGS. 3 A-D as a pop-up structure in the shape of a truck 2 and is characterized by a bottom panel 23, a top panel 9, and several side panels 3, 5, 17, 15, 21, 27. The panels include numerous flaps or tabs 1, 7, 11, 13, 19, 25, 29, 31, 33, 39, 41. In order to assemble the pop-up structure, the flattened construction is expanded in the direction shown by action arrow 52, i.e. by lifting panel 15. Flap 19 and flap 25 are folded inward at fold lines 46, 50. The bottom panel 23 is folded inward as shown by action arrows 56, 58, and tab 33 is folded at fold line 54 and inserted into the space between flaps 19, 25 and side panel 15. The structure 2 positioned so that panel 23 forms the bottom upon which the structure 2 rests. The electronic component, in this case a clock 37 is inserted into opening 43 of side panel 21 from the inside of the structure 2. The clock face-plate 35 is snapped onto the clock 37 via the pegs 14, 16, 18, 20 which fit into corresponding holes on the back side of the face-plate (see FIG. 12). Tabs 11, 13, 39 are folded inward at fold lines 60, 44, 62. Flap 7 is folded inward at fold line 42. Panel 5 is folded inward at fold line 40 and panel 3 is folded outward at fold line 38. The structure is closed by folding down the top panel 9 as shown by action arrow 90, positioning flap 1 behind panel 27, positioning flap 7 behind panel 15, and inserting tab 41 into slot 43 by folding inward at fold line 64.

In other aspects of the invention, the opening(s) for the electronic component(s) is/are positioned on alternate or additional panels of the structure 2, for example on one or more of panels 5, 3, 15, 17, and/or 27.

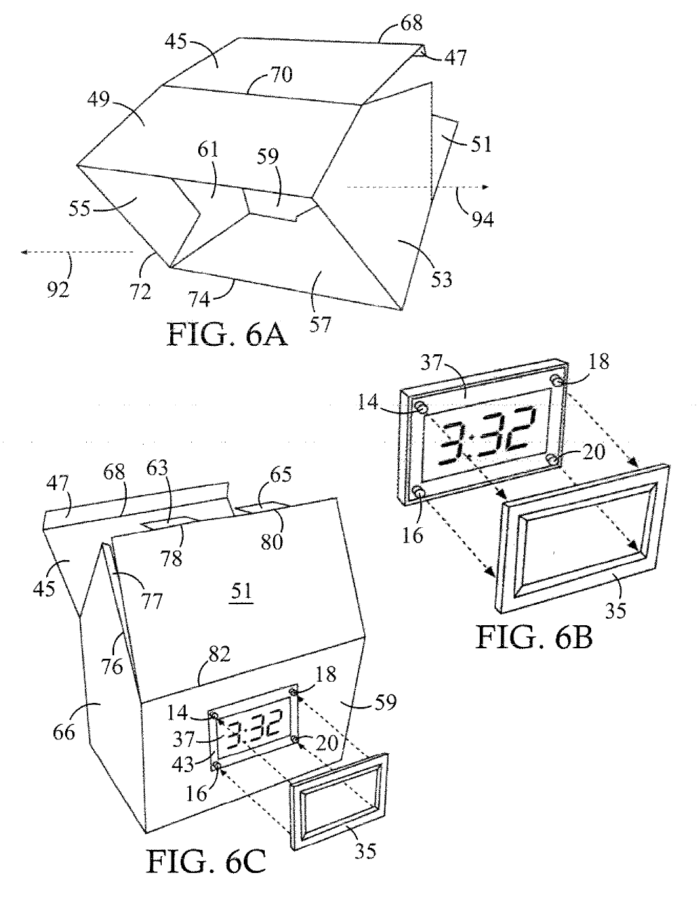

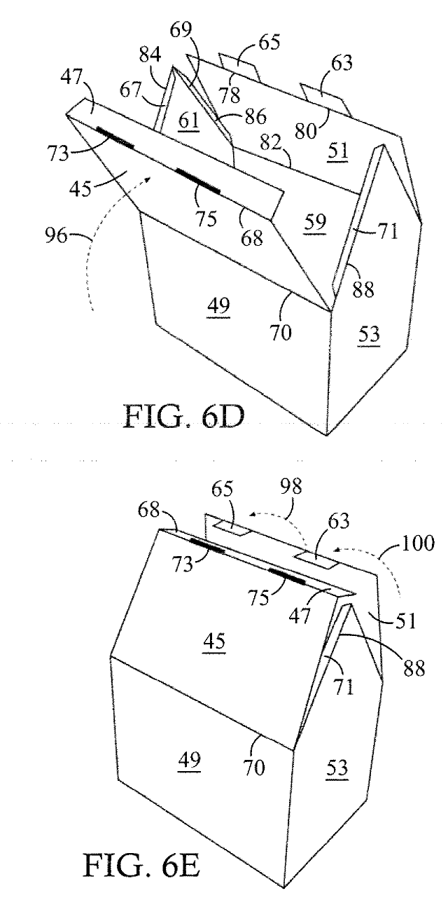

Another embodiment of the invention is shown in FIGS. 6 A-E as a pop-up structure in the shape of a house 4 and is characterized by a bottom panels 55, 57, two top panels 45, 51 and several side panels 49, 53, 59, 61. The panels include numerous flaps or tabs 47, 55, 63, 65, 67, 69, 71, 77. In order to assemble the pop-up structure 4, the flattened construction is expanded in the directions shown by action arrows 92, 94, i.e. by moving panels 53 and 61 away from each other. The bottom is assembled by pushing out from the center panels 55, 57 and others not shown. The clock face-plate 35 is snapped off of the clock 37 as shown in FIG. 6B. The clock 37 is inserted into opening 43 of side panel 59 from the inside of the structure 4. The clock face-plate 35 is snapped onto the clock 37 from the outside via the pegs 14, 16, 18, 20 which fit into corresponding holes on the back side of the face-plate (see FIG. 12). Flaps 67, 69, 71, and 77 are folded inward at fold lines 84, 86, 88, and 76 respectively. Flap 47 is folded inward at fold line 68. Top panel 45 is folded in the direction shown by action arrow 96. Top panel 51 is folded in the direction shown by action arrows 93, 100. Top panels 45 and 51 meet at a point. The structure is closed by folding flap 47 inward at fold line 68, folding tabs 63 and 65 at fold lines 80 and 78, respectively and inserting tabs 63 and 65 into slots 75 and 73, respectively.

In other aspects of the invention, the opening(s) for the electronic component(s) is/are positioned on alternate or additional panels of the structure 4, for example on one or more of panels 45, 49, 51, 53, and/or 61.

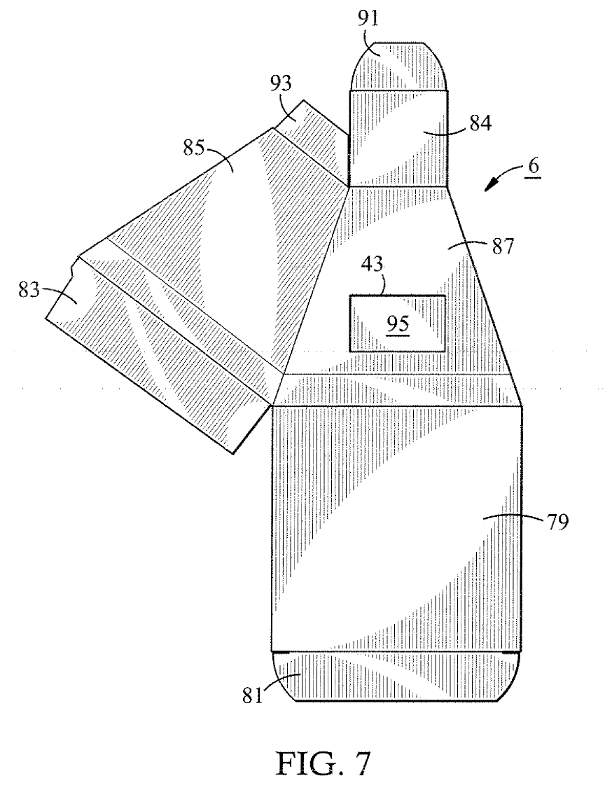

Another embodiment of the invention is shown in FIG. 4B (assembled) and FIG. 7 (unassembled) as a pop-up structure in the shape of a pyramid 6. It is characterized by a bottom panel 79, a top panel 89 and side panels 85, 87, 95 and one other not shown. The panels include numerous flaps and tabs including 81, 83, 91, 93. The structure 6 includes an opening 43 in panel 87 for an electronic component.

In other aspects of the invention, the opening(s) for the electronic component(s) is/are positioned on alternate or additional panels of the structure 6, for example on one or more of panels 85 and/or 95.

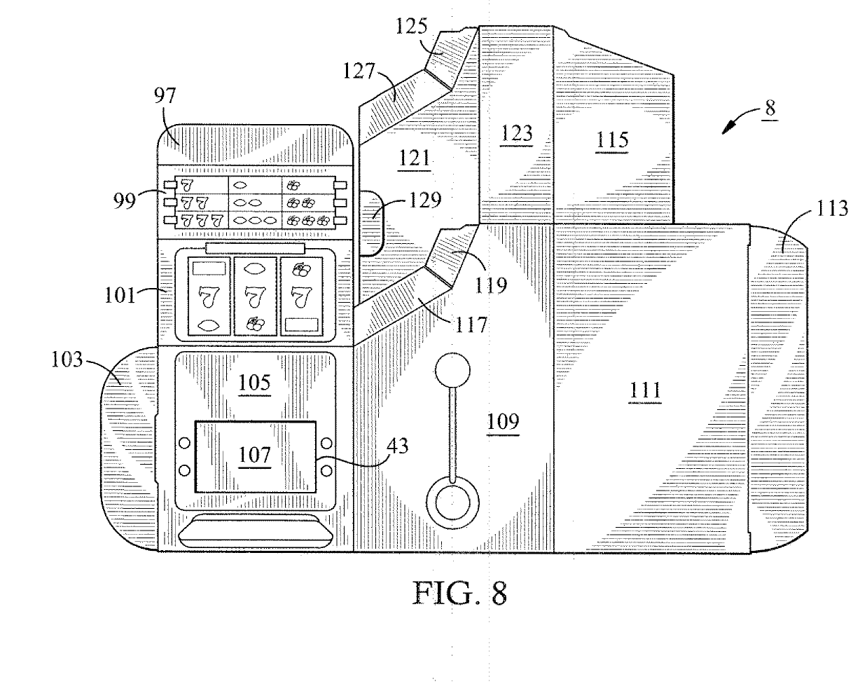

Another embodiment of the invention is shown in FIG. 4C (assembled) and FIG. 8 (unassembled) as a pop-up structure in the shape of a slot machine 8. It is characterized by a bottom panel (not shown), a top panel 123 and side panels 99, 101, 105, 107, 109, 111, 121. The panels include numerous flaps and tabs including 97, 103, 113, 115, 117, 119, 125, 127, 129. The structure 8 includes an opening 43 in panel 105 for an electronic component.

In other aspects of the invention, the opening(s) for the electronic component(s) is/are positioned on alternate or additional panels of the structure 8, for example on one or more of panels 99 and/or 101.

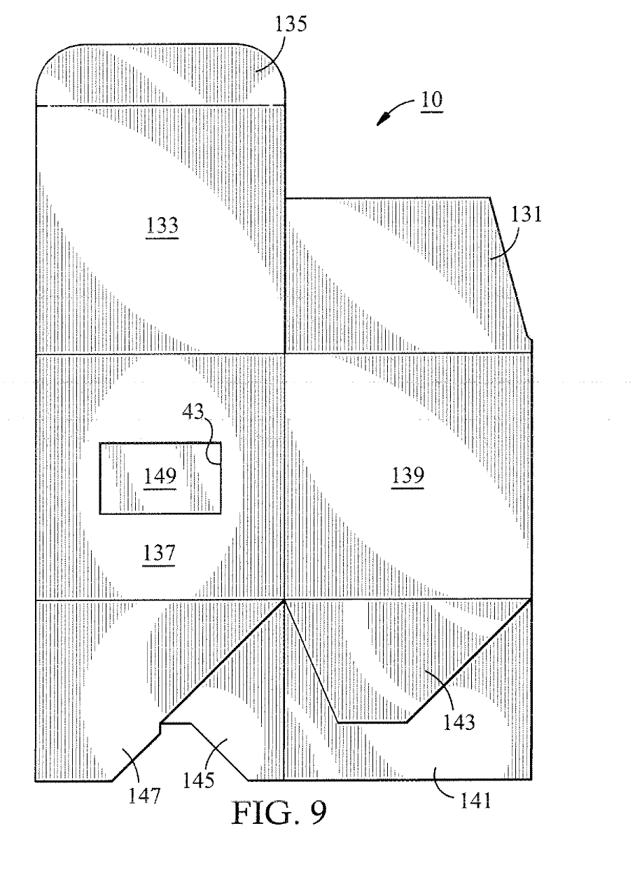

Another embodiment of the invention is shown in FIG. 4D (assembled) and FIG. 9 (unassembled) as a pop-up structure in the shape of a cube 10. It is characterized by panels 141, 143, 145, 147, which interlock to form a bottom or base, a top panel 133 and side panels 137, 139, 149 and one other not shown. The panels include numerous flaps and tabs including 131, 135. The structure 10 includes an opening 43 in panel 137 for an electronic component.

In other aspects of the invention, the opening(s) for the electronic component(s) is/are positioned on alternate or additional panels of the structure 10, for example on one or more of panels 139 and/or 149.

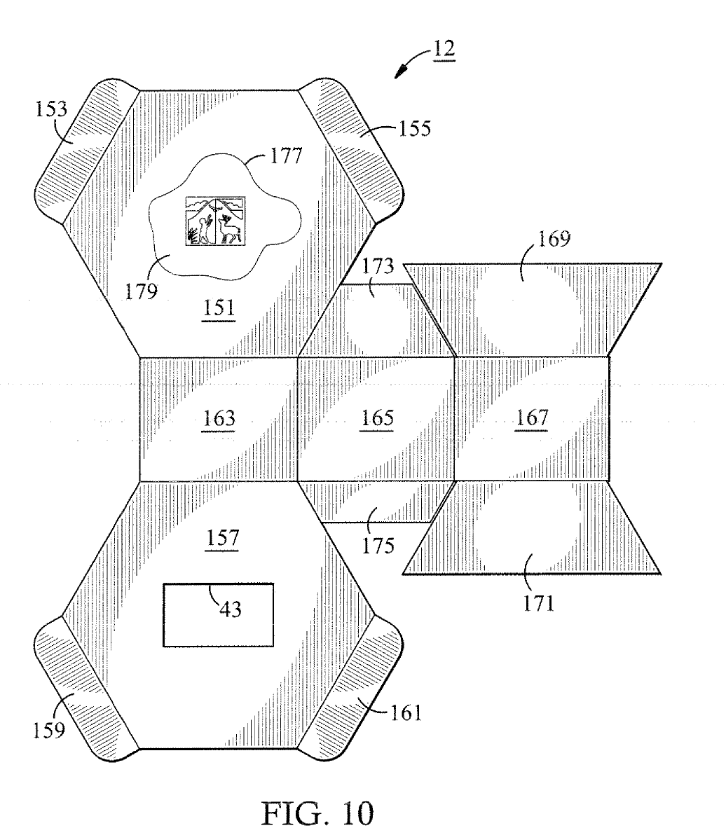

Another embodiment of the invention is shown in FIG. 4E (assembled) and FIG. 10 (unassembled) as a pop-up structure in the shape of a hexagon 12. It is characterized by panels 163, 165, 167, 175, 181, 183 and one other not shown which surround the perimeter of hexagonal panels 151, 157. The panels include numerous flaps and tabs including 153, 155, 159, 161, 169, 171, 173, 175. The structure 12 includes an opening 43 in panel 157 for an electronic component. An additional opening 177 is included in panel 151. A printed promotional advertisement 179 is inserted in opening 177. Alternatively, an opening can be provided in panel 151 for additional electronic components.

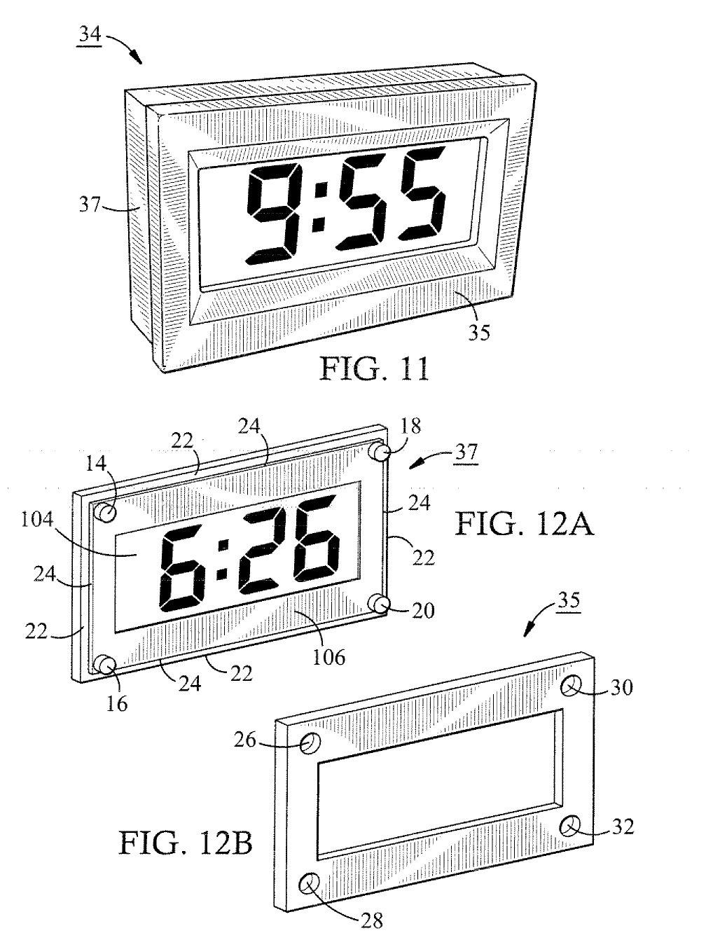

FIG. 11 is a picture of an assembled electronic component 34. In this example, the electronic component is a clock 37 with a face-plate 35. FIG. 12 shows the clock 37 and face-plate 35 in more detail. The clock 37 is characterized by raised pegs 14, 16, 18, 20; an edge 22, which extends to boundary 24. The edge 22 is slightly lower than the frame 106, which surrounds the display 104. The face-plate 35 is characterized by indentations or holes 26, 28, 30, 32 on the back side, which align with pegs 14, 16, 18, 20. The pegs 14, 16, 18, 20 snap into the holes 26, 28, 30, 32 to form an assembled component 34.

FIGS. 11 and 12 are meant to illustrate one embodiment of the electronic component of the invention. Additional embodiments include, but are not limited to calculators, calendars, weather stations, thermometers, radios, televisions, phones, speakers, two-way communication devices, alarms, motion or vibration detectors, data recorders, audio recorders, portable media players, running liquid crystal display (LCD) message banners or other viewing screens. The displays would be, as appropriate, dates, temperatures, barometric pressure, messages or other data. Where appropriate control buttons or touch screen controls would be included. Alternatively, controls could be provided externally, for example as a remote control device or integrated into a desktop or laptop computer.

The electronic component as shown in FIGS. 11 and 12 is rectangular in shape. Additional shapes for the electronic component include, but are not limited to, round, elliptical, triangular, square, pentagonal, hexagonal, heptagonal, octagonal, or irregular shapes.

The electronic component as shown in FIGS. 11 and 12 is attached to the pop-up structures or three-dimensional display structures of the invention by a face-plate. Additional means for attaching the electronic components to the structures include, but are not limited to, hooks, brackets, clips, pins, screws, and adhesives.

The above description and the views and material depicted by the figures are for the purpose of illustration only and are not intended to be, and should not be construed as, limitations on the invention. As an example, the structure can comprise a brochure holder, a pocket folder or any others not shown which will also include an electronic component(s). In addition, any other functional and/or aesthetic components may be used where desired rather than electronic component(s). Moreover, certain modifications or alterations may suggest themselves to those skilled in the art upon reading of this specification, all of which are intended to be within the spirit and scope of the present invention as defined in the attached claims.

What is claimed is:

1. An apparatus comprising a pop-up structure and one or more electronic component.

2. The apparatus of claim 1, wherein said pop-up structure is flat or substantially co-planar in an unassembled state and expands in size into a three-dimensional assembled state.

3. The apparatus of claim 2, wherein said pop-up structure is comprised of a stiff foldable material.

4. The apparatus of claim 3, wherein said foldable material is selected from the group consisting of paper, cardboard, leather and plastics.

5. The apparatus of claim 1, wherein said one or more electronic components are contained in at least one opening of the structure.

6. The apparatus of claim 5, wherein said one or more electronic components are held in at least one opening of the structure by an attachment means.

7. The apparatus of claim 5, wherein said attachment means is selected from the group consisting of face-plates, hooks, brackets, clips, pins, screws, and adhesives.

8. The apparatus of claim 1, wherein said electronic components are one or more selected from the group consisting of clocks, calculators, calendars, weather stations, thermometers, radios, televisions, phones, speakers, two-way communication devices, alarms, motion or vibration detectors, data recorders, audio recorders, portable media players, running liquid crystal display (LCD) message banners and other viewing screens.

9. The apparatus of claim 1, further comprising one or more printed elements selected from the group consisting of designs, logos, and advertisements.

10. The apparatus of claim 1, further comprising a desk organizer.
